(19) United States
(12) Patent Application Publication
(10) Pub. No.: US 2006/0190492 A1
(43) Pub. Date: Aug. 24, 2006

(54) Data processor and method for processing medical text

(75) Inventors: Sabine Karl, Erlangen (DE); Marco Lorenz, Erlangen (DE); Norbert Mukke, Herzogenaurach (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/356,889

(22) Filed: Feb. 16, 2006

(30) Foreign Application Priority Data
Feb. 21, 2005 (DE) 10 2005 007 850.8

(51) Int. Cl. G06F 7/00

(52) U.S. Cl. 707/104.1

(57) ABSTRACT

In a data processing system and an operating method therefor, a medical text is automatically read into an evaluation unit of the data processing system, medical terms (in particular in abbreviated form) are automatically searched for in the medical text using a rule set stored in the data processing system, a term identified by means of the rule set is compared with Latin terms stored in a first databank, the identified term is compared with terms classified according to diagnosis criteria and stored in a second databank, and after evaluation of both databanks, the technical term is replaced by a corrected (completed) term.

### BACKGROUND OF THE INVENTION

1. Field of the Invention

The present invention concerns a data processing system as well as an operating method therefor, for processing (editing) medical texts.

2. Description of the Prior Art

A system and a method for extraction and encoding of technical medical terminology is known, for example, from EP 0 929 870 B1.

Medical services are increasingly classified according to what are known as DRGs (disease-related groups, also known as diagnosis-related groups) as is known, for example, from DE 10 2004 013 651 A1, which concerns a medical data classification system. The DRG classification, a case-based system, in particular is intended to make the billing of services in health care more transparent.

### SUMMARY OF THE INVENTION

An object of the present invention is to further increase the use of classification systems with diagnosis criteria (in particular the DRG classification) in medicine.

This object is achieved according to the invention by a method for operation of a data processing system, as well as a data processing system for processing medical texts, wherein a medical text (for example a finding) is automatically read (imported) into an evaluation unit of a data processing system. The input of the text can ensue in any manner; in particular an input via keyboard input or per speech input is possible. Transfer from a data medium is likewise possible. In the medical text read into the evaluation unit, medical terms (in particular in abbreviated form) are automatically sought using a rule set stored in the data processing system. If a term in the text is identified by means of the rule set as a possible medical term, a comparison of the term with terms stored in two databanks ensues: the first databank contains Latin technical medical terms; the second databank contains technical terms that are classified according to diagnosis criteria, in particular according to the DRG system.

The term identified in the text is initially compared with terms of the first databank. This first step of the comparison with the databanks in particular serves to complete abbreviated technical terms. Furthermore, possible spelling errors can also be automatically corrected in this step. Moreover, non-Latin terms (in particular terms in the user's native language) can be replaced with Latin technical terms.

Independent of whether an input term was actually replaced by a different term in the first step of the comparison with the databanks, a comparison of the (if applicable, corrected) term with accounting-conforming terms stored in the second databank ensues in a subsequent second step. The accounting-conforming terms, in particular terms classified according to the DRG classification, are typically Latin technical medical terms. In the second step of the evaluation of the databanks, a non-Latin (in particular native language) medical term or a Latin technical term can thus be replaced by an accounting-conforming term, in particular Latin-medical-pathological or Latin-medical-anatomical term. If the second databank contains no accounting-conforming term (from the viewpoint of the diagnosis classification) term that could replace the evaluated term, the evaluated term is not changed. If applicable, the change implemented in the first step of the evaluation thus persists. In any case, a term identified as a possible medical term passes through a comparison with both databanks.

Particularly in the case of abbreviated terms in the original imported text, preferably various completed DRG-compatible terms are considered for replacement. In such a case, a term selection is automatically displayed to the user. The terms offered for selection can be organized according to predeterminable criteria. For example, the frequency of occurrence of a specific term in a text can be selected as an organization criterion. A prioritization of specific terms available for selection likewise can ensue in a context-sensitive (context-dependent) manner.

In an embodiment, not only technical medical expressions classified according to diagnosis criteria are stored in the second databank; but also codes associated with these are also stored. The codes can be, for example, numbers or arbitrary alphanumerical character combinations that can be used for accounting purposes. The codes also can be inserted as needed into the processed text automatically or after approval by the user. It is likewise possible to insert complete (entire) text blocks that are associated with a specific coding into the text.

Independent of whether codes are referenced, the automatic processing of the text can ensue either online (i.e. during the text input) or at a later point in time (for example during the night in batch operation). Although the latter variant allows no immediate control by the user, the resources of the data processing system are unloaded during the text acquisition and thus increase of the processing time by the data processing system during the reading of the text is avoided. In any case, it is reasonable to effect the automated processing of the text before the forwarding of the text, for example via a hospital-internal data network or a data network extending beyond this. In this manner it is ensured that the data transfer paths are not loaded by the (under the circumstances) multiple transfer of unprocessed or partially-processed texts, that may possibly present the risk of false interpretations. Moreover, storage space that would otherwise be necessary for unprocessed texts and/or partially-processed intermediate versions is saved.

The assurance of a uniform nomenclature by the use of the inventive method has the particular advantage that the processed texts are easily interpretable by the relevant specialists (in particular doctors), which leads to a further, significant time savings in addition to a simplified, particularly quick text creation. Moreover, misinterpretations in the evaluation of medical texts as well as in the accounting of medical services are precluded to a large extent by the uniformity of technical terms that is achieved. The method is particularly suited for the processing of diagnostic findings, but is likewise applicable for other medical texts (for example scientific works).

### DESCRIPTION OF THE DRAWINGS

FIG. 1 is a block diagram of a data processing system for processing medical texts in accordance with the invention.

FIG. 2 illustrates the structured processing of a medical text in the data processing system according to FIG. 1.

### DESCRIPTION OF THE PREFERRED EMBODIMENTS

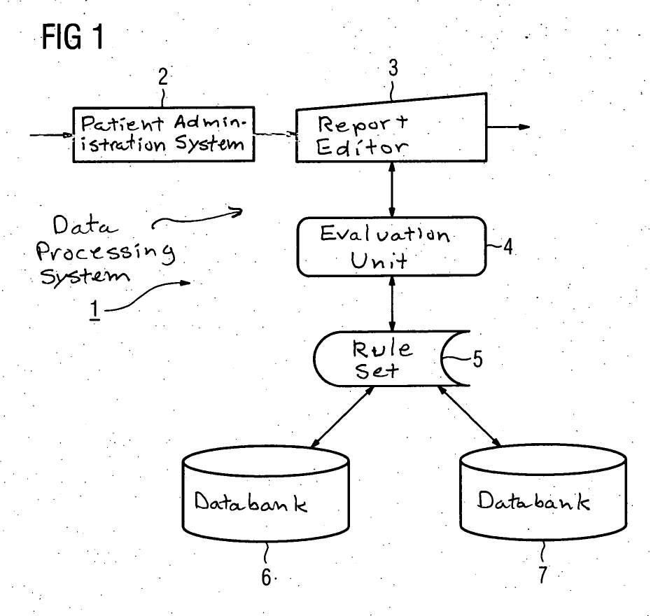

FIG. 1 schematically shows the design of a data processing system 1 for processing medical texts. The data processing system 1 is connected to a patient administration system 2 or is integrated into such a system. The patient administration system 2, for example, can be part of a comprehensive hospital information system (KIS). The patient administration system 2 likewise can be coupled in a data-related manner with a radiology information system (RIS) and/or a cardiology information system (CIS). The patient administration system 2 offers the possibility to open a report editor 3. Alteratively, the report editor 3 can be operated independently of the patient administration system 2. The report editor 3 can call up a text analysis module (acting as an evaluation unit 4) automatically or by means of a suitable user input in order to evaluate and (in the event that it is necessary) to correct a medical text. For this purpose, the evaluation unit 4 uses a rule set 5 and has access to two databanks 6, 7.

The cited components 2-7 of the data processing system 1 need not necessarily be physically separate from one another. FIG. 1 merely illustrates a conceptual division, but any of the components 2-7 can be merged and/or realized by means of software. The medical text to be evaluated is imported into the evaluation unit 4. The data input can ensue via a keyboard, a scanner, a microphone or other input means, or combinations thereof. The evaluation unit 4 preferably automatically becomes active as son as the user inputs a text, for example by typing or natural speech.

The imported text is evaluated in an ongoing manner using the rule set 5, whereby it is initially checked whether a word or a series of words could be a technical medical term. If this first question is affirmed by the data processing system 1, the further analysis ensues under access to the first databank 6 as well as the second databank 7. The first databank 6 contains Latin technical terms, in particular Latin-medical-anatomical as well as Latin-medical-pathological terms. The terms contained in the second databank 7 are structured according to diagnostic criteria, namely according to the DRG system. Furthermore, the second databank 7 contains codes associated with the individual DRG terms, which codes are in particular to be used in the accounting of medical services. Deviating from the exemplary embodiment (shown simplified), the databanks 6, 7 could also access common data sets.

An example of a text component that is detected as a medical term and automatically changed by means of the data processing system 1 is the expression “vasoconstriction of the femoral artery”. Instead of a formulation in English, a formulation in another language (for example in German) could also exist. An entry can be input into the data processing system 1 to designate which language should be assumed as the input language, insofar as Latin technical medical expressions are not already input. In the present case, the expression identified as a possible technical medical term is automatically converted into the term “stenosis arterial femoralis”. This illustrates a typical application case of the data processing system 1, namely the translation of colloquial terms into Latin technical language.

Furthermore, the data processing system 1 is set up in terms of programming such that an incorrectly-written technical medical term is automatically replaced by the corresponding term in the correct notation or spelling. Instead of an abbreviated term, the completely written-out term is likewise inserted into the text. The correct spelling and abbreviation check is thereby realized by means of the first databank 6, while the second databank 7 contains information beyond this, in particular in a format conforming to accounting.

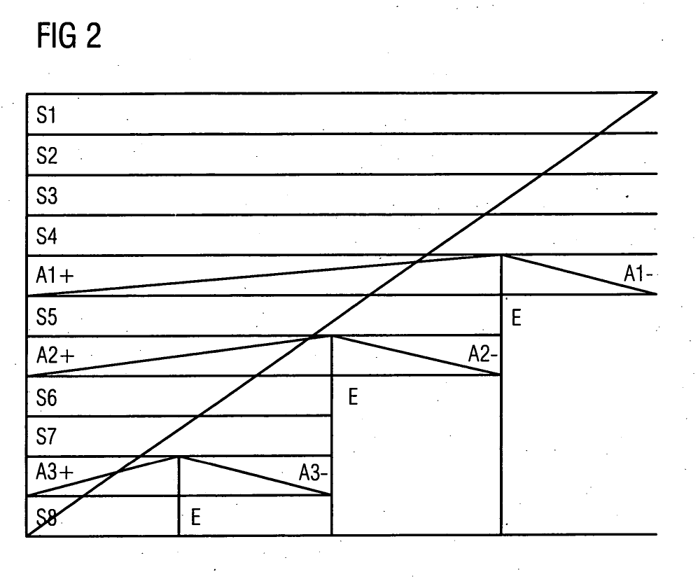

The program workflow in the data processing system 1 is subsequently described more precisely using FIG. 2, which shows a diagnosis in the manner of a structured chart (structogram). The report editor 3 is opened in the first program step S1. In the next program step S2, a plug-in is started that launches the intelligent software tool which edits (processes) the medical text. After the start of the software tool, the rule set 5 is loaded in a program step S3. This is the requirement for the software tool “reading along” with the input text in the program step S4, which is to be equated with the processing in the evaluation unit 4 in the representation according to FIG. 1. Each input term, which can also be formed of multiple words, is evaluated in a first query A1 as to whether it is potentially a technical medical term. An affirmation of a query is indicated in the structured chart according to FIG. 2 by an appended “Plus”, a negation by an appended “Minus”.

In the following, the term “greatest gluteal muscle” is considered as an input text component. This term is identified as a relevant medical term in the query A1. Otherwise, the program workflow within the structured chart would end with the program end E and the automatic checking could be continued with the next term in the text. However, because a medical term is to be examined more closely in the present case, the first databank 6 is called up (invoked) in the program step S5. In a second query A2 it is tested whether Latin equivalents exist for the term input in German. This is the case here; the term “musculus glutaeus maximus” is found. In the program step S6, this term is inserted into the text in place of the original English term.

Deviating from this example, it would also be conceivable for the user of the data processing system 1 to directly type in the term in Latin. In this case, the data processing system 1 also represents a significant aid. After input of the letters “musc”, thus the first four letters, the data processing system 1 automatically completes the word to “muscle”. The letters “glut” are automatically completed to “glutaeus” in a corresponding manner. The evaluation unit 4 now detects that there are various possibilities for the continuation of the term, namely the appending of “minimus”, “medius” or “maximus”. If the query A2 leads to such an ambiguity, a term selection is automatically displayed to the user, whereby the selected terms can be arranged in a context-sensitive manner.

Because a term was selected wholly automatically or with the aid of the user in the program step S6, an access to the second databank 7 ensues in the next program step S7. In a third query A3, it is checked whether the technical term found in the program steps S5-S6 can be replaced with a term conforming to accounting, i.e. with the term compatible with the DRG codes. Additionally, it is automatically checked whether auxiliary information regarding the corresponding diagnosis are available in the second databank 7. In the illustrated exemplary embodiment (musculus glutaeus maximus), the described pathology is, for example, an abscess after iatrogenic intervention (spray injection). There exist various DRGs for this, so an appropriate selection is in turn provided to the user of the data processing system 1. The selected information is inserted into the medical text to be processed in the program step S8. The entire text is processed in this manner, such that ultimately a text is available with very precise formulation which can be handled easily for accounting purposes, but also offers a good basis for scientific evaluations.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for operating a data processor to process medical text, comprising the steps of:
automatically entering medical text into an evaluation unit of a data processor having a rule set stored therein;
in said evaluation unit, automatically searching for medical terms in said medical text using said rule set;
after a medical term is identified using said rule set, automatically comparing the identified medical term with Latin terms stored in a first databank accessible by said data processor;
also comparing the identified term with terms that are classified according to diagnosis criteria and that are stored in a second data bank accessible by said data processor; and
dependent on both said comparison with said Latin terms and said comparison with said diagnosis criteria, automatically replacing said medical term in said medical text with a corrected term.

2. A method as claimed in claim 1 comprising storing said diagnosis criteria in said second databank in a classification according to the DRG system.

3. A method as claimed in claim 1 comprising storing said diagnosis criteria in said second databank associated with respective codes for business accounting.

4. A method as claimed in claim 3 comprising, in said second databank, additionally storing text blocks for insertion into said medical text associated with said business accounting codes.

5. A method as claimed in claim 1 wherein said comparison with said Latin terms and said comparison with said diagnosis criteria produce multiple candidate terms for use as said corrected term, and automatically displaying said multiple candidate terms comprising selected terms stored in at least one of said first databank or said second databank.

6. A data processing system processing medical text, comprising:
a data processor having a rule set stored therein;
an evaluation unit in said data processor in which medial text is automatically entered; and
said evaluation unit automatically searching for medical terms in said medical text using said rule set, and after a medical term is identified using said rule set, automatically comparing the identified medical term with Latin terms stored in a first databank accessible by said data processor, and also comparing the identified term with terms that are classified according to diagnosis criteria and that are stored in a second data bank accessible by said data processor, and dependent on both said comparison with said Latin terms and said comparison with said diagnosis criteria, automatically replacing said medical term in said medical text with a corrected term.

7. A data processing system as claimed in claim 6 wherein said second databank stores said diagnosis criteria in a classification according to the DRG system.

8. A data processing system as claimed in claim 6 wherein said second databank stores said diagnosis criteria associated with respective codes for business accounting.

9. A data processing system as claimed in claim 8 wherein said second databank additionally stores text blocks for insertion into said medical text associated with said business accounting codes.

10. A data processing system as claimed in claim 6 wherein said evaluation unit, as a result of said comparison with said Latin terms and said comparison with said diagnosis criteria produces multiple candidate terms for use as said corrected term, and wherein said data processing system comprises a display unit connected to said data processor, said evaluation unit automatically displaying said multiple candidate terms at said display unit as selected terms stored in at least one of said first databank or said second databank.
